(19) United States
(12) Patent Application Publication
(10) Pub. No.: US 2016/0104260 A1
(43) Pub. Date: Apr. 14, 2016

(54) Practitioner Career Management Assessment Interviewer Method and Tool

(71) Applicants: CLAIRE Technologies, Pasadena, MD (US); Alexton Incorporated, Alexandria, VA (US)

(72) Inventors: Robert J. MENRAD, Pasadena, MD (US); Sophia MARNELL, Alexandria, VA (US)

(21) Appl. No.: 14/511,668

(22) Filed: Oct. 10, 2014

(51) Int. Cl. G06Q 50/20; G06Q 50/26; G06Q 10/10

(52) U.S. Cl. CPC G06Q 50/2057; G06Q 10/10; G06Q 50/26

(57) ABSTRACT

The practitioner career assessment is a method and device for providing career development and advancement management within hiring organizations. The method includes the steps of consolidating all of a user's career experiences, knowledge, skills and abilities, and automating career guidance and a career pathway roadmap of the user's career development and advancement. As a result, the assessment is operated by a hiring organization, under the complete control of the user, and conducted in a confidential manner, free of any judgment prejudice, and devoid of known and unknown biases associated with human factor or supervisory factors to provide guidance and create a career pathway roadmap to goals and advancement. The device includes a number of modules including a system access, user homepage, user profile or census, core and optional goal assessments, assessment generation, guidance, outreach, reporting, and requirements traceability matrix (RTM) modules.

### STATEMENT REGARDING FEDERALLY SPONSORED RESEARCH

The invention described herein was made in part by employees of the United States Government and may be manufactured and used by or for the Government of the United States of America for governmental purposes without the payment of any royalties thereon or therefor.

### CROSS REFERENCES TO RELATED APPLICATIONS

Not Applicable

### BACKGROUND

A. Technical Field

The present subject matter relates to the field of career and professional development. More specifically, the present subject matter is directed to a practitioner career management method and tool for generating private and unbiased practitioner assessment results that bridge the gap between a hiring organization's needs and a practitioner's career path and aspirations.

B. Discussion of the Prior Art

Historically, career management tools have been used to test and track the skills of employees and have been utilized for recruitment and hiring needs. Career management tools and assessments have been conducted by humans (i.e. supervisors and/or employees themselves), and as such, whether conducted by supervisors or employees, these human conducted assessments have been subject to biases that affect the results. Consequently, the majority of commercial career management tools do not conduct true competency testing that allows hiring organizations to fully gain knowledge of employees' skills and provide private and unbiased results indicating personalized growth, training and future steps.

To meet the career development requirements of a hiring organization, there is a need to generate and complete career assessments that identify the knowledge, skills and abilities required by an organization, an occupation, and the practitioner. By incorporating these aspects into career management tool assessments, not only do the overall proficiencies of hiring organizations increase to create a robust workforce, but practitioners also have the ability to receive ongoing career development and advancement.

### SUMMARY

In an aspect of the present subject matter, a method of providing career development and advancement management within NASA (The National Aeronautics and Space Administration) comprises the steps of consolidating a NASA employee's career experiences; consolidating a NASA employee's career experiences, knowledge, skills and abilities; automating career guidance and a career pathway roadmap of the NASA employee's career development and advancement based on the NASA employee's career experiences, knowledge, skills and abilities; and providing the NASA employee with a career management tool including a core assessment, the career guidance, and the career pathway roadmap of the NASA employee's experiences, knowledge, skills and abilities, wherein said career management tool is operated by NASA, under complete control of the NASA employee, and confidentially generates the career assessment so as to be free of any judgment prejudice.

In a second aspect of the present subject matter, a method of providing career development and advancement management within NASA comprises the steps of accessing a non-transitory interactive computing system; accessing a homepage wherein buttons or links are displayed to a NASA employee and connect to a plurality of steps for providing the NASA employee with a career assessment; prompting the NASA employee to create a profile by inputting data, thereby forming profile data, wherein said profile data includes NASA employee personal information, career information, and outreach based information; utilizing the profile data to generate census data, a core assessment, and display a plurality of core assessment interview questions, wherein said core assessment interview questions are designed to validate the NASA employee's competencies and proficiencies against a baseline competencies and proficiencies related to a NASA employee previous career position, a current career position, a next career position, and a goal career position; automatically generating results based on the NASA employee's answers to a plurality of core assessment interview questions, wherein said career management tool is operated by NASA, under complete control of the NASA employee, and confidentially generates the career assessment so as to be free of any judgment prejudice; generating career guidance utilizing said results; and generating outreach services utilizing said results.

In a third aspect of the present subject matter, a method of providing career development and advancement management within NASA comprises the steps of accessing a non-transitory interactive computing system; accessing a homepage wherein buttons or links are displayed to a NASA employee and connect to each step for providing the NASA employee with results; prompting the NASA employee to create a profile by inputting data, thereby forming profile data, wherein said profile data includes NASA employee personal information, career information, and outreach based information; utilizing the profile data to generate a core assessment and display a set of core assessment interview questions, wherein said core assessment interviews the NASA employee through a plurality of questions to validate the NASA employee's competencies and proficiencies against a baseline competencies and proficiencies related to a NASA employee previous career position, a current career position, a next career position, and a goal career position, and wherein said career management tool is operated by NASA, under complete control of the NASA employee, and confidentially generates the career assessment so as to be free of any judgment prejudice; generating career guidance utilizing said results, wherein said career guidance displays the career assessment including a career roadmap, deltas, and assistance to the NASA employee, wherein the career assessment of the NASA employee's competencies and proficiency levels provide a personalized result that is generated for baseline comparison with a NASA employee current position as well as the NASA employee next position in a NASA employee career track, and wherein the assessment deltas provide the difference between the baseline proficiencies and a NASA employee assessed proficiency level for each relevant competency; and generating outreach services utilizing said results.

In a fourth aspect of the present subject matter, a method of providing career development and advancement management within the government comprises the steps of consolidating a government employee's career experiences, knowledge, skills and abilities; automating career guidance and a career pathway roadmap of the government employee's career development and advancement in a career position based on the government employee's career experiences, knowledge, skills and abilities; and providing the government employee with a career management tool including a core assessment, the career guidance, and the career pathway roadmap of the government employee's experiences, knowledge, skills and abilities, wherein said career management tool is operated by a governmental organization, under complete control of the government employee, and confidentially generates results so as to be free of any judgment prejudice.

In a fifth aspect of the present subject matter, a method of providing career development and advancement management within the government comprises the steps of accessing a non-transitory interactive computing system; accessing a homepage wherein buttons or links are displayed to a government employee and connect to a plurality of steps for providing the government employee with results; prompting the government employee to create a profile by inputting data, thereby forming profile data, wherein said profile data includes government employee personal information, career information, and outreach based information; utilizing the census data to generate a core assessment and display a set of core assessment interview questions, wherein said core assessment interview questions are designed to validate the government employee's competencies and proficiencies against a baseline competencies and proficiencies related to a government employee previous career position, a current career position, a next career position, and a goal career position; automatically generating results based on the government employee's answers to a plurality of core assessment interview questions, wherein said career management tool is operated by a governmental organization, under complete control of the government employee, and confidentially generates results so as to be free of any judgment prejudice; generating career guidance utilizing said results; and generating outreach services utilizing said results.

In a sixth aspect of the present subject matter, a method of providing career development and advancement management within the government comprises the steps of accessing a non- transitory interactive computing system; accessing a homepage wherein buttons or links are displayed to a government employee and connect to each step for providing the government employee with a career management tool; prompting the government employee to create a profile by inputting data, thereby forming profile data, wherein said profile data includes government employee personal information, career information, and outreach based information; utilizing the profile data to generate a core assessment and display a set of core assessment interview questions, wherein said core assessment interviews the government employee through a plurality of questions to validate the government employee's competencies and proficiencies against a baseline competencies and proficiencies related to a government employee next career position, and wherein said career management tool is operated by a governmental organization, under complete control of the government employee, and confidentially generates results so as to be free of any judgment prejudice; generating career guidance utilizing said results, wherein said career guidance displays results including a career roadmap, deltas, and assistance to the government employee, wherein results of the government employee's competencies and proficiency levels provide a personalized result that is generated for baseline comparison with a government employee current career position as well as the government employee next career position in a government employee career track, and wherein deltas provide the difference between the baseline proficiencies and a government employee assessed proficiency level for each relevant competency; and generating outreach services utilizing said results.

In a seventh aspect of the present subject matter, a method of providing career development and advancement management within a corporation comprises the steps of consolidating a corporate employee's career experiences, knowledge, skills and abilities; automating career guidance and a career pathway roadmap of the corporate employee's career development and advancement in a corporate human resources office; and providing the corporate employee with a career management tool including the career guidance and the career pathway roadmap of the corporate employee's experiences, knowledge, skills and abilities, wherein said career management tool is operated by the corporate human resources office, is under complete control of the corporate employee, and confidentially generates results so as to be free of any judgment prejudice.

In an eighth aspect of the present subject matter, a method of providing career development and advancement management within a corporation comprises the steps of accessing a non-transitory interactive computing system; accessing a homepage wherein buttons or links are displayed to a corporate employee and connect to each step for providing the corporate employee with a career management tool; prompting the corporate employee to create a profile by inputting data, thereby forming profile data, wherein said profile data includes corporate employee personal information, career information, and outreach based information; utilizing the profile data to generate census data, a core assessment, and display a set of core assessment interview questions, wherein said core assessment interview questions are designed to validate the corporate employee's competencies and proficiencies against a baseline competencies and proficiencies related to a corporate employee previous career position, a current career position, a next corporate position, and a goal career position; automatically generating results based on the corporate employee's answers to a plurality of core assessment interview questions, wherein said career management tool is operated by a corporate human resources office, under complete control of the corporate employee, and confidentially generates the career assessment so as to be free of any judgment prejudice; generating career guidance utilizing said results; and generating outreach services utilizing said results.

In a ninth aspect of the present subject matter, a method of providing career development and advancement management within a corporation comprises the steps of accessing a non-transitory interactive computing system; accessing a homepage wherein buttons or links are displayed to a corporate employee and connect to each step for providing the corporate employee with a career management tool; prompting the corporate employee to create a profile by inputting data, thereby forming profile data, wherein said profile data includes corporate employee personal information, career information, and outreach based information; utilizing the profile data to generate a core assessment and display a set of core assessment interview questions, wherein said core assessment interviews the corporate employee through a plurality of questions to validate the corporate employee's competencies and proficiencies against a baseline competencies and proficiencies related to a corporate employee previous career position, a current career position, a next corporate position, and a goal career position; and wherein said career management tool is operated by the corporate human resources office, under complete control of the corporate employee, and confidentially generates results so as to be free of any judgment prejudice; generating career guidance utilizing said core assessment result, wherein said career guidance displays the results including a career roadmap, deltas, and assistance to the corporate employee, wherein the career assessment of the corporate employee's competencies and proficiency levels provide a personalized result that is generated for baseline comparison with a corporate employee current corporate position as well as the corporate employee next corporate position in a corporate employee career track, and wherein deltas provide the difference between the baseline proficiencies and a corporate employee assessed proficiency level for each relevant competency; and generating outreach services utilizing said results.

In another aspect of the present subject matter, a device for providing career development and advancement management comprises a non-transitory interactive computing system, a system access module, a homepage module, a census module, a core assessment module, a generate assessment module, a guidance module, an outreach module, a reporting module, and a requirements traceability matrix module.

A practitioner career management method and tool, such as a consolidated learning assessment interviewer for recommended experiences (CLAIRE), integrates and streamlines hiring organizations' current hiring and evaluation processes and enhances the organization's career development framework to better map practitioners' career pathways, identify new career growth opportunities, and guide practitioners in attaining future career goals. The practitioner is the user of the career management tool. Developing an intuitive, integrated, and comprehensive application assists the practitioner in career planning and provides the practitioner with continuous career management. Further, ongoing practitioner development provides for a consistent maturation of the workforce, thus increasing the overall proficiency of the organization, while continually populating a diverse candidate pool to meet hiring organizations' needs.

The career management tool described herein offers an automated means for assessing a user's competencies and proficiencies without introducing any bias so as to be objective and free of any judgment prejudice, operated by the hiring organization, under complete control of the user, in complete confidence, and containing a level of objectivity incapable of being achieved by current career management methods and tools. The foregoing and other aspects provide an unbiased assessment of the user's competencies at various proficiency levels, identify a gap between the performance required by the hiring organization and the practitioner's current performance leading to career advancement, and provide methods for closing these gaps. Thus, this user-friendly, real-time, intelligent career development application and non-transitory interactive computing system or tool assists the practitioner in managing their career development and progression without bias and in complete confidence. Furthermore, an unbiased career assessment improves succession planning within a hiring organization and increases the pool of qualified candidates for career positions at levels of all skill.

The foregoing and other features and advantages of the present subject matter are more readily apparent from the following detailed description. The detailed description proceeds with references to the accompanying drawings.

### BRIEF DESCRIPTION OF THE DRAWINGS

The accompanying drawings, which are included to provide a further understanding of the subject matter and are incorporated in and constitute a part of this specification, illustrate non-limiting embodiments of the subject matter, and together with the description, serve to explain the principles of the subject matter:

In the drawings:

FIG. 1 illustrates the decomposition of each subsystem into components and how the components interact with one another.

FIG. 2 is a flow diagram illustrating the main module and process steps for providing career guidance.

FIG. 3 is a flow diagram illustrating the career assessment tool or system access module and process for authorizing users to utilize the system.

FIG. 4 is a flow diagram illustrating the homepage module and process for accessing the homepage.

FIG. 5 is a flow diagram illustrating the user profile/census module and process for establishing and maintaining user profile/census data.

FIG. 6 is a flow diagram illustrating the core assessment module and process for conducting the core assessment.

FIG. 7 is a flow diagram illustrating the goal assessment module and process for conducting the goal assessment.

FIG. 8 is a flow diagram illustrating the assessment result generation module and process for generating assessment results.

FIG. 9 is a flow diagram illustrating the guidance module and process for providing guidance based on the assessment results.

FIG. 10 is a flow diagram illustrating the outreach module and process for providing outreach services.

FIG. 11 is a flow diagram illustrating the reporting module and process for reporting results.

FIG. 12 is a flow diagram illustrating the requirements traceability matrix (RTM) and process for tracking modules.

### DETAILED DESCRIPTION OF THE EMBODIMENT

As used herein, “artificial intelligence” (AI) refers to the science and engineering of making intelligent computer systems, as well as intelligent software, which uses primarily both algorithmic and symbolic methods of problem solving to understand and duplicate human intelligence.

As used herein, “assessment” refers to a systematic process for gathering information to validate the user's competencies against his/her current job title and career pathways.

As used herein, “career development” refers to an ongoing process in which practitioners remain active, continually working toward their goals.

As used herein, “career pathway” refers to a plurality of articulated educational and training programs and services that enables practitioners, often while they are working, to advance over time to successively higher levels of employment in a given industry or occupational sector. Each step on a career pathway is designed explicitly to prepare practitioners to progress to the next level of employment.

As used herein, “career planning” refers to an activity in which practitioners identify opportunities, set goals and devise action plans to attain those goals.

As used herein, “career roadmap” refers to a set of guidelines (for future actions) or a plan that assists practitioners to identify their level in the career management and development process and what they should do next to obtain their goal(s). A career roadmap may be presented in a graphical representation.

As used herein, “census” refers to a collection of required information on a user that includes profile data including basic information such as name and job title as well as specific and unique information associated with the user's career development such as desired career goal-that is needed for the interview assessment and system assessment.

As used herein, “competencies” refers to measurable patterns of knowledge, skills, abilities, and other characteristics that an individual should possess in order to perform work roles or occupational functions successfully.

As used herein, “data mining” refers to a class of database information analysis that seeks hidden patterns in groups of data that can be used to predict future behavior.

As used herein, “decision support system” (DSS) refers to both an approach and a methodology which uses an interactive, flexible and adaptable computer-based information system to support all phases of decision making and to provide solutions to specific business management problems or issues.

As used herein, “deltas” refer to differences between core competencies in the user's current role compared against career goal requirements, illustrating variances within core competencies

As used herein, “guidance counselor” refers to the virtual role assumed by the CLAIRE system. As a guidance counselor, the CLAIRE system serves as the professional or individual trained to screen, to evaluate, to advise employees on career plans, and other career-oriented development matters.

As used herein, “job title” refers to a position held by an employee. A job title can describe the responsibilities of the position and/or the level of the job.

As used herein, “proficiency” refers to the state of having or showing knowledge, ability, competency or skill in a profession or field of study.

As used herein, “proficiency level” refers to the degree of knowledge and proficiency required varies from one position to another based on the tasks and duties involved. There is a predefined proficiency level for each competency.

As used herein, “profile” refers to a collection of user's required information needed for the interview and system assessments. Information includes name, job title, and specific or unique information related to the user's career development and desired career goal. Profile data is used to create and update the census.

As used herein, “system assessment” refers to a unique critical key attribute and output of the career assessment system functionality. It is a system-generated analysis or validation of the user's measured patterns of knowledge, skills, abilities, and other characteristics needed to perform work roles or occupational functions successfully (competencies). The system assessment reviews and explores differences between the user's current competencies as applied to his/her job title and the defined requirements of that job title.

As used herein, “user” refers to any practitioner or employee, respective to the career assessment tool or system, who has the appropriate authorization to the career assessment system.

The method of providing career development and advancement management via a career management tool or system involves simplifying, consolidating and automating the career development process while providing an objective assessment of a user's skills and deficiencies to provide advancement management through guidance and a career pathway roadmap to achieving career goals. Functioning as a virtual guidance counselor, the career management method and tool provides continuous management of employee career development and advancement. Further, the user is provided notifications of relevant information on jobs, seminars, and training related to the user's next and goal career position, while being guided by the system on how to build a professional network. A professional network generally constitutes the people and organizations that the user comes into contact with while performing their duties on the job. The system guides the user by encouraging the user to expand and build upon their professional network by suggesting conference and organizations in which the user can become involved.

A user's career experiences, knowledge, skills and abilities are consolidated by analyzing and validating the user's measured patterns of these and other characteristics needed to successfully perform roles required for a career position or occupational functions. A user's experiences include supervisory experience, project management experience, procurement cycle experience, procurement experience, and operating plan experience. A user's knowledge includes information gained from the user's career experiences and may also include information gleaned from secondary education. A user's skills include any expertise that the user develops through his or her career experiences. A user's abilities include the user's aptitude to think and act independently, competence based on career experiences, and competence based on inherent cognitive logic.

Automated career guidance is accomplished through an interactive virtual guidance counselor where a Graphical User Interface (GUI) facilitates interaction between a non-transitory interactive computing system and the user. The interactive computing system is accessed by a menu item or link for the career assessment available in a designated portal. For NASA, the designated portal is an Advanced Concepts and Formulation Office (ACFO) Portal. In other hiring organizations, including but not limited to federal, state, and local governmental agencies and private industry, a portal is designated by the hiring organization.

The GUI is developed to ensure a user friendly and real-time interactive approach, while introducing the ability and functionality of an objective career development, advancement, and monitoring system, and standardization. As a result, the GUI provides a virtual guidance counselor that encourages collaboration and interaction in real-time between the user and the GUI while understanding the user's career goals and capturing user data for establishing a profile, census, and assessments, thereby creating a plan for successful career development and advancement.

The GUI utilizes AI programs for tutorial interfaces, introduction of features, and key discussion points throughout in order to acquaint the user with the system capabilities, retrieve data, and process user needs. The GUI is designed for a user to develop trust in the system and understand the functions of the career management method and tool. The GUI front end is oriented towards helping users achieve their personal career goals, capture user career experiences, and user career tasks. The GUI utilizes human computer interaction (HCI) and AI that are designed to fit into the various learning styles of users, their existing work practices with NASA or the hiring organization, NASA Mission needs or the hiring organization's needs, and requirements. The GUI also adapts itself to the current user and does not make the user adapt to the system by observing the user's vision capabilities, motor capabilities, browsing patterns, and preferences thereby providing a higher level of usability for the user.

### Functional Decomposition

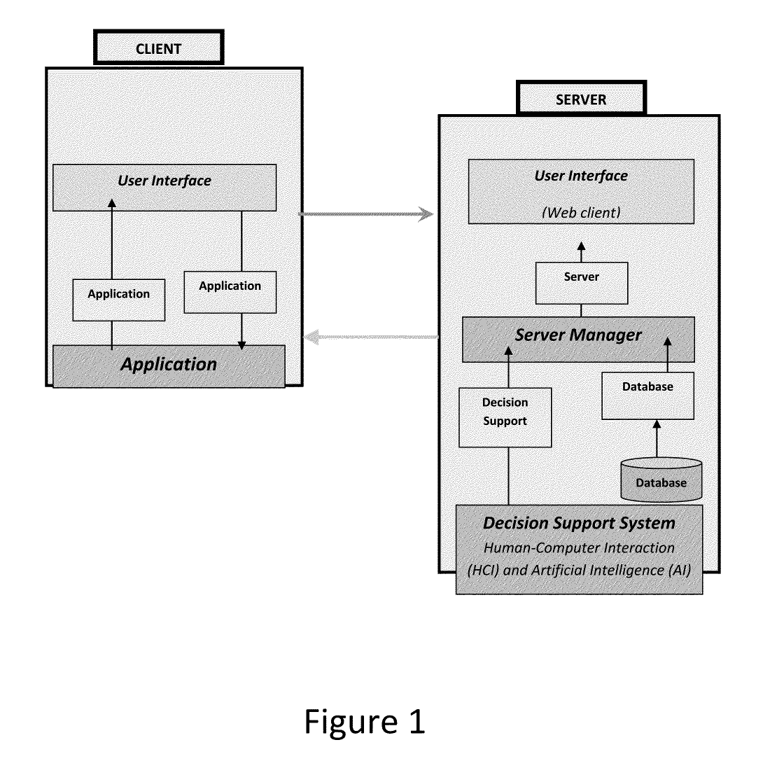

FIG. 1 illustrates the decomposition of an interactive software-based system into components and shows how the components interact with one another. The subsystem is divided into a primary three layered architecture: a user interface layer, an application layer, and a decision support system layer. Each primary layer has its own interface that other layers use to interact with the primary layer.

Referring again to FIG. 1, the user interface layer may be referred to as the presentation layer and works to transform data into the form that the system layer can accept. Furthermore, the user interface layer contains an observer object and updates its data, using data from the observable system layer, via the observer pattern. The observable system layer handles threads, logs, and converts messages from the user interface layer into communications and sends them to the decision support layer. Each layer is also a component that can be individually updated or replaced, as long as the interface remains the same. Additionally, the GUI is part of the user interface layer, and as such, allows users to interact with the system in a real-time fashion.

Additional layers include a server subsystem layer that contains a web client component, a server manager component, a database component, and a decision support component. The web client component is a simple desktop system that connects to the server and follows the same rules for communication as the client. The server manager component handles the threads, message parsing, and database queries. The database component stores all of the data for the system.

The application layer of the career management method and tool is designed as an interactive software-based system. Furthermore, the application layer is intended to help the database and decision support layer (DSL) compile information from a combination of raw data and business models to identify and make decisions to support the functionality of the system by receiving raw data, interacting with software systems, and . Since the DSS layer is a layer in the Open Systems Interconnection (OSI) seven-layer model and in the TCP/IP protocol suite, it is the only layer that directly interacts with the end user.

Furthermore, the application layer supports system and end-user processes. Communication partners are identified, quality of service is identified, user authentication and privacy are considered, and any constraints on data syntax are identified in the application layer. Every component at the application layer is system-specific, and the application layer provides application services for file transfers, e-mail, and other network software services.

Tiered application architectures are also a part of the application layer, as the application layer is not the application which performs the communication. The service layer, however, is the layer that performs the communication by interacting with the application layer to communicate with applications to provide the services listed below:
1. Ensures that the other party is identified and can be reached;
2. If appropriate, authenticate either the message sender or receiver or both;
3. Ensures that necessary communication resources exist;
4. Ensures agreement at both ends about error recovery procedures, data integrity, and privacy;
5. Determines protocol and data syntax rules at the system level;
6. Simple Mail Transfer Protocol;
7. File transfer;
8. Web chat;
9. Email clients;
10. Network data sharing;
11. Virtual terminals;
12. Various file and data operations.

The decision support layer contains built-in HCI and AI and acts as a DSS which, along with data mining, which allows the system to utilize data provided by the user for an individual interview.

Referring again to FIG. 1, the user interface layer contains an observer object and updates observer object data using data from the observable system layer via the observer pattern. The system layer handles threads, logs, and converts messages from the user interface layer into communications and sends them to the DSL. Each layer is also a component that can be individually updated or replaced, as long as the interface remains the same.

Additionally, the server subsystem contains a web client component, server manager component, database component, and decision support component. The web client component is a simple desktop system that connects to the server and follows the same rules for communication as the client. The server manager component handles the threads, message parsing, and database queries. The database component stores all of the data for the system.

The data stored in the system includes information about career tracks/pathways, competencies, and specific user items. The data stored in the central database is queried by the server which receives messages from the system.

For the career management method and tool to be fully functional, the system database is populated with all required and approved hiring organization career data provided by human resources experts. For NASA, this includes NASA Flight Projects Directorate (FPD) career data provided by the NASA Community ACFO Subject Matter Experts (SME's). For other hiring organizations, career data includes the data provided by the organization's SME's. Within local, state and federal governmental agencies, as well as private industry, SME's may include, but are not limited to, human resources department professionals, a person(s) with the highest level of technical expertise in areas relevant to the user's career pathway, or any person who is an authority in a particular area.

Prior to the employee interview, the application contains relevant information such as career pathways, job titles, core competencies, and associated proficiency levels for career tracks. For NASA, this may include FPD career pathways and information specific to Program/Project Management, Resource Management and Administration Professional career tracks. In other hiring organizations, the human resources department sets the criteria for information relevant to career pathways, job titles, core competencies, and associated proficiency levels for career tracks. This information is utilized by automatically matching the information against the individual user profile to logically produce an appropriate plurality of questions related to each proficiency level within a career pathway, conduct the assessment, and produce individualized career guidance. The number of proficiency levels may range from at least two levels to as many levels as the hiring organization chooses.

The data elements are designed to support the various functionalities for the career management method and tool and the user types. The data is organized by tables in a relational database and contains the following features listed below:
1. Data Dictionary Repository provides a comprehensive data dictionary showing data element name, type, length, source, validation rules, maintenance [create, read, update, delete (CRUD) capability], data stores, outputs, aliases, and description;
2. Categorizing the data elements appropriately and focus on the governance and quality are consistent and precise with the functionality of the career assessment in the Functional Requirements Document (FRD); and
3. Security and access.

For data validation, the data collected by the career assessment from the user and SME's is monitored, and analyzed against a set of data quality objectives and requirements criteria designed to meet acceptance and compliance. The career assessment relies on analytical data to provide a reliable basis for decision making, reporting, and most other activities on every level of usage and functionality.

The DSL contains HCI and AI that is built-in and acts as a DSS which, along with data mining, allows the system to utilize data provided by the user for an individual interview (see FIG. 1). The ultimate goal of both HCI and AI is to make the user interface more effective and easier to use. HCI's main objective is to allow the user regardless of learning styles, uses, and abilities to interact with the career assessment making the system easier to use. The main objective of AI models human thinking and the mechanics of the system through cosmetic attributes. Both processes are intertwined into the career management method and tool. The DSS within the career management method and tool is a computer-based information system that supports business or organizational decision-making activities. With respect to NASA, the DSS serves the ACFO management, operations, and planning levels of an organization and makes decisions, which may rapidly change and not easily be specified in advance.

Decision support systems can be either fully computerized, human or even a combination of both. The career management method and tool uses a combination of both by including real-time interaction by a user against the computerized DSL and humanistic logic within a DSL and database.

This layer functions as the decision aid to collect user data, create interaction questioning for an unbiased assessment, and automatically supports the career advancement and development for each user. Each function is not only automatic but unique for each transaction by the user.

The design and flow of the interface is designed around the idea of collecting, analyzing real-time interaction, searching, updating information, and displaying returned information. One of the most significant elements of the user interface is the visibility of the system's status. To achieve a higher level of system visibility, the career assessment may use Asynchronous Javascript and XML (AJAX). This allows users to update portions of a web page at any time without refreshing the entire page thereby achieving faster response times and providing responsiveness and interaction such as desktop applications.

Animation may be used to increase the interactive user experience with the career assessment. The human eye notices and responds to movement that causes the user to provide more data than required of the system. Other main key components of the interface include:
1. Enabling keyboard shortcuts
2. Offering personalization options
3. Displaying help messages that attract the eye
4. Tab navigation
5. Animation
6. Easy help functionality The career management method and tool interface is compliant with Section 508 of the Rehabilitation Act (29 U.S.C. 794d) which was enacted by Congress in 1998 as an amendment to the Rehabilitation Act. This act requires Federal agencies to make their information technology and written documents accessible to people with disabilities. The Section 508 standards for the system are broken into three compliance requirements (i) technical requirements, (ii) functional performance criteria, and (iii) requirements for information, documentation, and support.

### Career Management Process Flows and Modules

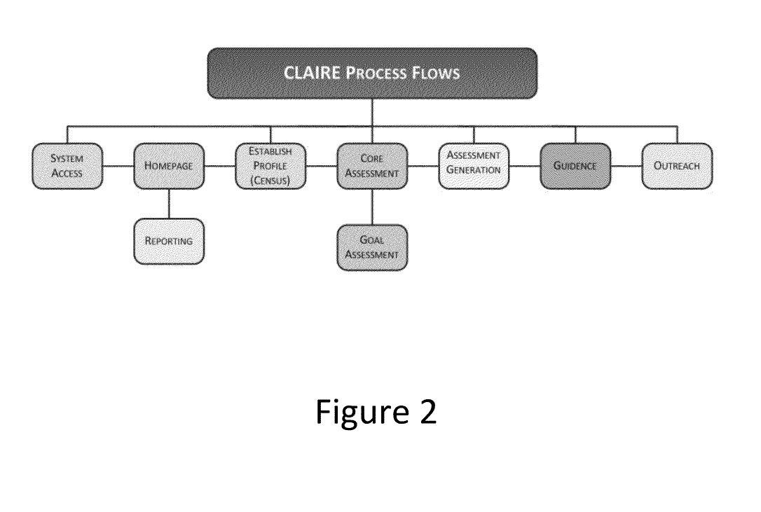

Referring now to FIG. 2 (which illustrates the main module and process steps for providing career guidance), the entire career management tool is segmented into seven main process steps or functional areas along with three sub-process areas.

Since the career management tool is designated as a system with user discretion, as to the level of participation, users may choose to bypass any number of these process steps. The career management tool points out however, that full utilization of system capabilities can only be attained by user participation in all of the steps.

An unbiased assessment is confidentially generated and free of any judgment prejudice. Further, NASA or another hiring organization is the operator of the career management tool, but the user has complete control over the career assessment. Practitioner utilization of the career assessment is self-defined. The career management method and tool is designed as a voluntary system with the user maintaining complete control as to their degree of participation. The user controls the extent and visibility to which their supervisor has regarding assessment participation and system information. With the utilization of the career management tool up to the discretion of the employee, it is anticipated that practitioner usage falls into three main levels of system participation:
System Management Guidance—User fully utilizes the system to its full capability. The user or practitioner profile information is populated, the interview and the career management tool assessments are completed, and individualized tool guidance is generated. The practitioner interacts with the career management tool on an ongoing basis to keep their profile, assessment, and guidance current.
Self-Management Guidance—User may participate in the lowest level of functionality. The lowest level includes the completion of the user profile process.
No Utilization (None Active)—User does not currently utilize the career management tool. For some organizations, self-management guidance participation is required. Therefore, lower level participation results in a limitation of available benefits.

As illustrated in FIG. 2, the seven main process steps are:
1. System Access
2. User Homepage
3. User Profile
4. Core Assessment & Goal Assessment (optional)
5. Assessment Generation
6. Guidance
7. Outreach

The three sub-process areas are:
1. Goal Assessment
2. Reporting
3. Requirements Traceability Matrix (RTM) Each of the seven process steps and modules functions as follows:
1. User Access: User logs into the career management tool.
2. Homepage: User utilizes the career management tool homepage for organization reference information and to access the other modules of the career management tool.
3. Establish Profile: User inputs basic demographic and specific job related information that is used to custom tailor the assessments and customize outreach. The user profile data is used to create and update census data for the entire hiring organization.
4. Core Assessment Interview: The career management tool guides the user through an assessment process that asks questions relating to competencies and proficiencies for their current position and against the next position on their current career track.
4.5. Goal Assessment Interview (User's Option): The career management tool guides the user through an assessment process that asks questions relating to competencies and proficiencies for their current position, the next position on the user current career track, and a stated goal position, if the user chooses to complete the goal assessment interview.
5. Assessment Generation: The career management tool analyzes the answers received from the profile and the work-related questions to provide an assessment of the user's competency and proficiency levels.
6. Guidance Generation: The career management tool's virtual guidance counselor capability provides a roadmap to assist the user in achieving the levels of proficiencies for career advancement.
7. Outreach and Notifications: The career management tool provides the user with unique information directly corresponding to the user's career roadmap and any competencies of which the user may be below baseline.

### System Access

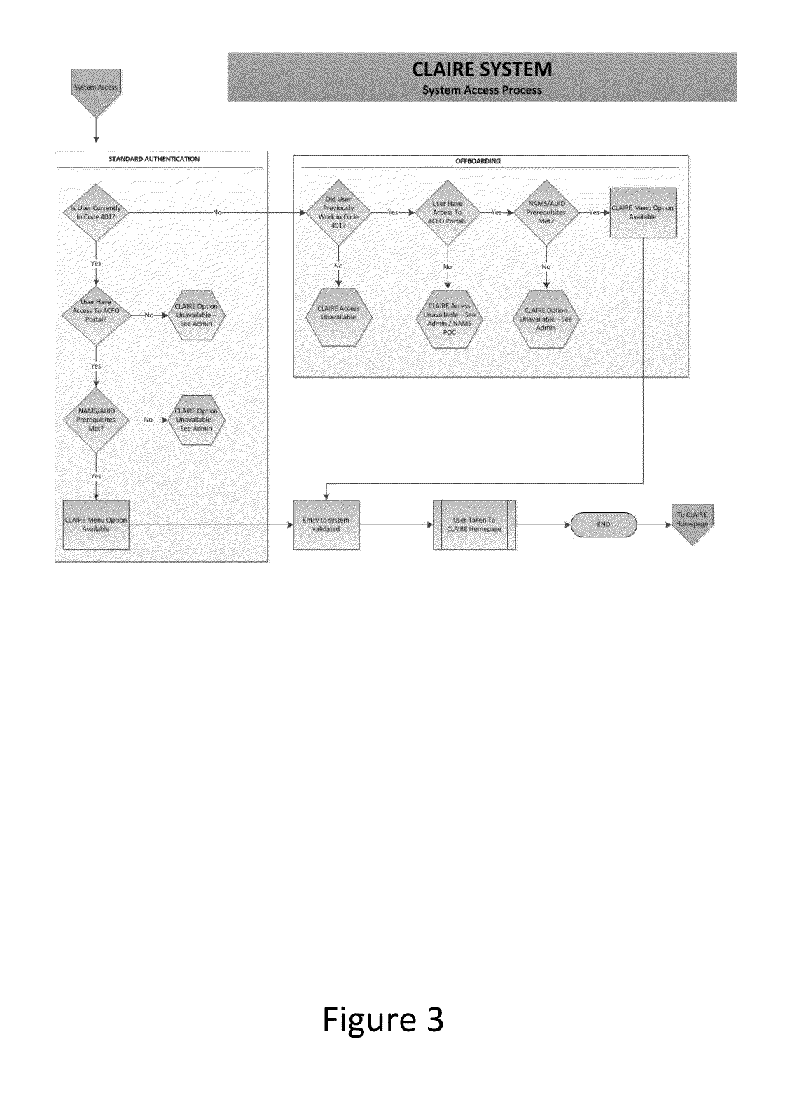

FIG. 3 illustrates accessing the non-transitory interactive computing system or tool. More specifically, FIG. 3 shows how the career management method and tool incorporates a high degree and multiple layers of computer security and information assurance principles and techniques, in order to protect its users from unauthorized access, use, disclosure, disruption, modification, or destruction in order to provide all five pillars of computer security: availability, integrity, authentication, confidentiality, and non-repudiation.

The career management tool also includes measures that provide for the restoration of its database and information system by incorporating protection, detection, and reaction capabilities. Based on the sensitivity of the system, specifications for the following minimum levels of integrity controls are designed:
Internal security to restrict access of critical data items to only those access types required by users.
Audit procedures to meet control, reporting, and retention period requirements for operational and management reports.
Application audit trails to dynamically audit retrieval access to designated critical data.
Standard tables to be used or requested for validating data fields.
Verification processes for additions, deletions, or updates of critical data.
Ability to identify all audit information by user identification, network terminal identification, date, time, and data accessed or changed.

With respect to NASA, the security design incorporates and requires collaboration with the following Information Technology groups to ensure compliance:
Integration with NASA Account Management System (NAMS)
Directory Lookup Integration (Enterprise Directory)
NATT (NASA Application Tracking Tool)
Identity Management and Account eXchange (idMAX) System
NASA Agency Forest (NAP)
EAuthentication (The eAuthentication infrastructure provides a centralized authentication interface for NASA's web-based applications.)
NASA Public Key Infrastructure (PKI)
NASA Enterprise Directory
Desktop Components/RSA SecurID Token Infrastructure
Application Integration Decision Tree

With respect to other hiring organizations, the security design may incorporate collaboration with the following Information Technology groups to ensure compliance:
Integration with a system for requesting and maintaining accounts for IT systems and applications
Employee Directory
Business Tracking Tool
Gateway to the tools necessary to gain access to IT systems, to update personal information in employee information directories, and (for new employees) to obtain a badge or credentials
Providing active employee directory authentication and authorization services
EAuthentication (The eAuthentication infrastructure provides a centralized authentication interface for the hiring organization's web-based applications.)
Hiring Organization's Public Key Infrastructure (PKI)
Primary Online or Electronic Phone and Information Directory
Desktop Components/RSA SecurID Token Infrastructure
Application Integration Decision Tree

The career management tool is also developed to include and support Information Privacy which is both an attribute as well as a goal of information assurance and protection. Information Privacy is closely related to the core information security doctrine of confidentiality not only in controlling access to information but also in controlling access to information disclosure.

Also shown in FIG. 3, users have authorization to gain access to the hiring organization's network. Within NASA, the user is authorized to access the NASA network and approved request by an identified Flight Projects Directorate (FPD) Point of Contact (POC). Only NASA Goddard Space Flight Center (GSFC) government employees having appropriate NASA NAMS authorization have access to the career management tool. Users who leave the organization have their access to the career assessment rescinded. Also within NASA, the ACFO administrators are responsible for activating and deactivating access to the career assessment. Likewise, within other hiring organizations, administrators or designated points of contact are responsible for activating and deactivating access to the career management tool.

Referring to FIG. 3, the system access steps and module are illustrated. A menu item or link for the career management tool is available in a designated hiring organization portal. For NASA, the portal is an ACFO Portal. Further, for NASA hiring needs, once a user attempts to access the assessment, entry into the system is only validated if all NAMS and ACFO business rules are met.

First, the system determines if the user current job location is the ACFO or was previously the ACFO, designated by user job code locations 401 and 402, respectively. If the rules have been satisfied, the system then determines if the NAMS and Agency User ID (AUID) prerequisites have been met. If the prerequisites have been satisfied, an access permitted response is generated, the homepage welcomes a user and provides a system introduction, and/or system maintenance information is provided as necessary. If the user does not or previously did not work in job locations 401 or 402, respectively, then an access denied response is generated. If the user NAMS/AUID prerequisites are not met, then an access denied response is generated.

For other hiring organizations, the system determines the user's previous and current job locations, and whether or not any user prerequisites established by or under the control of someone within the hiring organization have been met. If the prerequisites have been satisfied, then an access permitted response is generated, the homepage welcomes the user and provides a system introduction, and/or system maintenance information is provided as necessary. If the user does not or previously did not work in a hiring organization job location, then an access denied response is generated. If the user's identification and authentication prerequisites are not met, then an access denied response is generated. System Perspective: The system does not allow the user access unless the organization's security requirements have been met and approved. Within NASA, authorization is provided by the FPD POC. Within other hiring organizations, approval is provided by a point of contact designated by the hiring organization.

User Perspective: Users having proper authorization are able to utilize the system based on user roles.
ACFO or Hiring Organization Perspective: This process allows the organization to manage the user base within the application.

### User Homepage

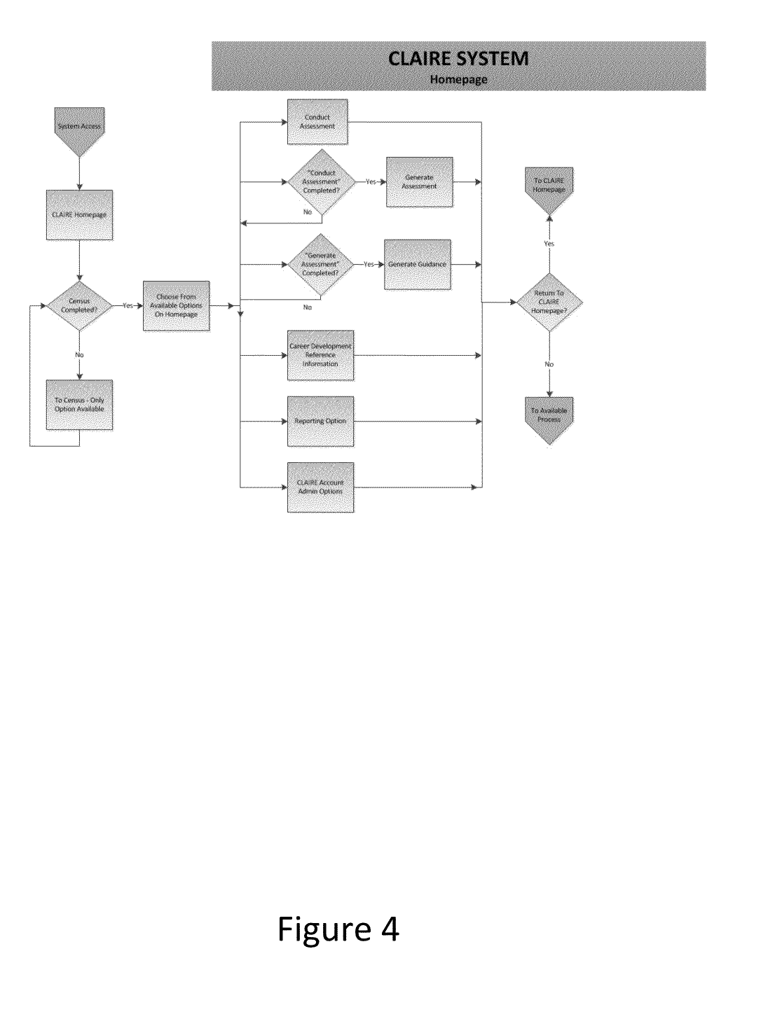

Relevant and dynamic information is presented to the user throughout the user's ongoing use of the career management tool to make the Homepage functional on several levels. Referring now to FIG. 4, upon successfully logging into the career management tool, the user is taken to the career management tool homepage which is the main launch point for activities throughout the system.

The homepage welcomes the user and provides a system introduction and/or system maintenance information as necessary. Furthermore, the homepage displays buttons or links to a plurality of steps and system modules for providing the user with a career assessment, guidance on proceeding through the system, and/or next steps in completing the career assessment. The homepage provides resources for the user to obtain help using the system, and a logout button displayed on the homepage provides the user with the ability to logoff the system.

As illustrated in FIG. 4, the homepage determines if a user has completed a profile. If the user has not completed the profile, then the homepage directs the user to the profile where it is the only homepage option available. If the user has completed the profile, then the homepage allows the user to choose from available homepage options including conducting an assessment, selecting a conduct assessment completed option, selecting a generate assessment completed option, career development reference information, reporting and career assessment account administration options.

When the conduct assessment completed option is selected, a generate assessment option is displayed for user completion. When the generate assessment completed option is selected, a generate guidance option is displayed for user completion. Both the conduct and generate assessment completed options allow the user to complete the assessment, return to the homepage, or logoff.

System Perspective: The system does not allow access to the homepage unless the predetermined NASA ACFO's or hiring organization's security requirements are met and approved by a point of contact. Users may not proceed through the system unless certain business rules are met.
User Perspective: Users with proper authorization are able to access the homepage and other career management tool modules once dependent module requirements are satisfied.
ACFO or Hiring Organization Perspective: This process allows NASA ACFO or hiring organizations to dictate the career management tool user experience as needed and prioritize the readiness/importance of immediate metrics reporting.

### User Profile

After generating an access permitted response, the system navigates the user to the profile module. The system then retrieves NAMS data before beginning the user profile process. For non-NASA hiring organizations, the system then retrieves information or data from all IT systems and applications related to the user. The questions included in the profile process are required and used by the career management tool to determine how the remainder of the system interacts with the user and its availability to the user. The system displays a message that includes instructions, the user's name, and the date the profile was last accessed.

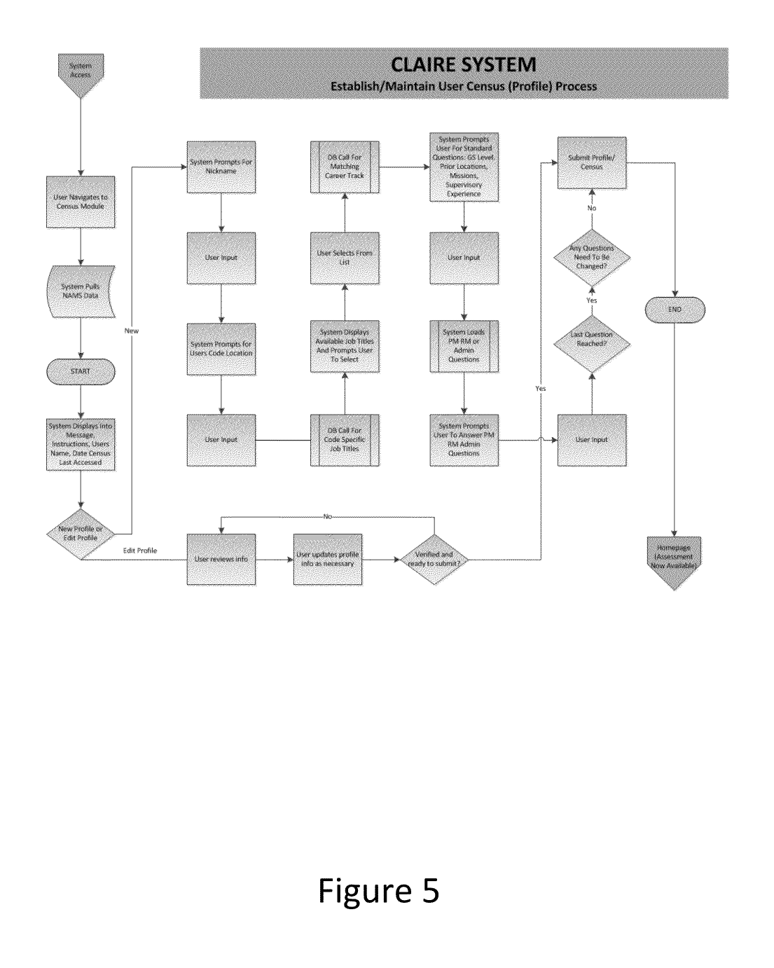

As illustrated in FIG. 5, the system determines when there is an existing user profile or if a non-existing or new profile needs to be created. When a profile does not exist, the system prompts the user to create a new profile. Completing a new profile is initiated by selecting the system's create profile option. On the other hand, when there is an existing user profile, the system displays the profile for the user's review. Completing an existing profile is initiated by selecting the system's update profile option located next to the create profile option.

The presence of an existing a user profile causes the system to prompt the user to update, verify, and submit the existing profile. Prior to verifying and submitting the profile, the system allows the user to review the user profile information. A census receives profile data from all users following submission of a new or existing profile. Common profile data solicited includes user personal information (i.e. nickname, email address, telephone number, education, etc.).

The user profile information also includes the user's career information. Career information includes the user's current job location, current career position, current career track, next career position, standard questions regarding basic information about the user regardless of the user career position or career track.

In the non-limiting case of NASA, career information also includes current general schedule (GS) level, total years of service at NASA (in the order of years at ACFO, GFSC, and NASA), in house and/or out of house missions, prior work locations, supervisory experience and the number of people supervised, current and previous project management track information, out of house vendor information, resources managed and at which locations, the maximum resources budget managed and at which locations, procurement cycle experience and at which locations, Source Evaluation Board (SEB) or standards procurement experience and at which locations, current and previous resource management experience, resource management experience and at which locations, resource management budget information and at which locations, procurement cycle experience and at which locations, years of experience in need to populate an operating development plan and NASA Planning Programming Budgeting and Execution (PPBE) process, years of experience in need to populate cost estimating technical work products, current and previous administrative support experience. Additionally, career information includes whether the user is a FPD employee, FPD new business employee, detailee to the FPD new business organization, detailee organization name, detailee organization code, detailee organization sub-code name, detailee organization sub-code, detailee organization sub-code job title, detailee organization sub-code job title code, program organization name, program organization code, program organization sub-code name, program organization sub-code number, program organization job title, program organization job title code, confirmation of program organization sub-code career track, confirmation of program organization sub-code career pathway, experience in formulation pre-phase a, experience in formulation phases a-f, experience in aeronautics research, experience in exploration, experience in sciences, experience in sciences sub-cateogories astrophysics, earth sciences, planetary and helio-physics, experience in space operations, experience in space operations sub-categories ISS, STS, network or other, experience in observatory management, experience in instruments, experience in instruments sub-categories ism and flight management, experience in ground systems management, experience in launch vehicles, experience in launch vehicles sub-categories balloons, STS, COTS, sounding rockets, ELV and other, team experience in category product, project, program, tiger team, anomaly, element/subsystems, category instrument spacecraft/ground data systems teams, leader experience in categories member of a team but not the leader, leader of a small ground team, leader of a large team, leader of multiple teams, leader of leaders, prompt the user about a future goal position, identify the career goal job title, verify the career track of goal job title, verify the career path of goal job title, identify the goal job title, prompt the user to indicate other career or development goals, whether related or unrelated to the user current position, and outreach based questions.

In the non-limiting case of non-NASA hiring organizations, career information includes position, title, total years of service, prior work locations, supervisory experience and the number of people supervised, current and previous management track information, out of house vendor information, resources managed and at which locations, the maximum budget managed and at which locations, procurement experience and at which locations, years of experience in need to populate an operating development plan, years of experience in need to populate cost estimating work products, current and previous administrative support experience. Additionally, career information includes whether the user is an employee, detailee or contractor. Furthermore, career information includes leader experience in a team but not the leader, leader of a small ground team, leader of a large team, leader of multiple teams, leader of leaders, prompt the user about a future goal position, identify the career goal job title, verify the career track of goal job title, verify the career path of goal job title, identify the goal job title, prompt the user to indicate other career or development goals, whether related or unrelated to the user current position, and outreach based questions.

The user's answers to outreach based questions allow the system to match specific discovered organizational learning opportunities with users who have expressed such interests. Regarding these outreach based questions, the system prompts the user to indicate other career or development goals that the user would like to achieve that may or may not be directly related to the user current career position. For example, outreach based questions include rotating to a different project or job, seeking a mentor(s), volunteering for a task force, detail or process action and reengineering team, attending conferences and seminars both on and off-site, attending commercial and contracted courses, and obtaining on-the-job guidance from someone who is more experienced or an expert in a specific area.

Still referring to FIG. 5, during the initial career assessment session, users are prompted to provide baseline information needed to establish an individual census and career information. Some specific fields presented for system population are determined by the user's current position. For example, if the user's job title identifies the user as a project manager, then the system may prompt the user for information regarding project management experience (ex. years of experience, size of projects managed, etc.). In contrast, an administrative professional would be asked to populate fields relevant to their specific job title. The specific fields presented to the user are determined by the system's backend processes.

System Perspective: The system includes the capability of interacting with and prompting the user for data needed to provide the best guidance for career advancement. This information is used to create interview questions specifically chosen for the individual user and subsequently generate a user's personal assessment.
User Perspective: Providing user profile information such as detailed career/job experiences, job title and description, goals, and interests allows for the career assessment's interaction to be individualized for each user. The user has the ability to maintain this information as the user progresses through their career.
Hiring Organization Perspective: Collecting profile data and incorporating the profile data in a census is essential to utilizing the full functionality of the system. This initial process step benefits the organization as participating users become invested in improving their organizational skills, pursuing career goals, and increasing productivity in the workforce.

### Core Assessment

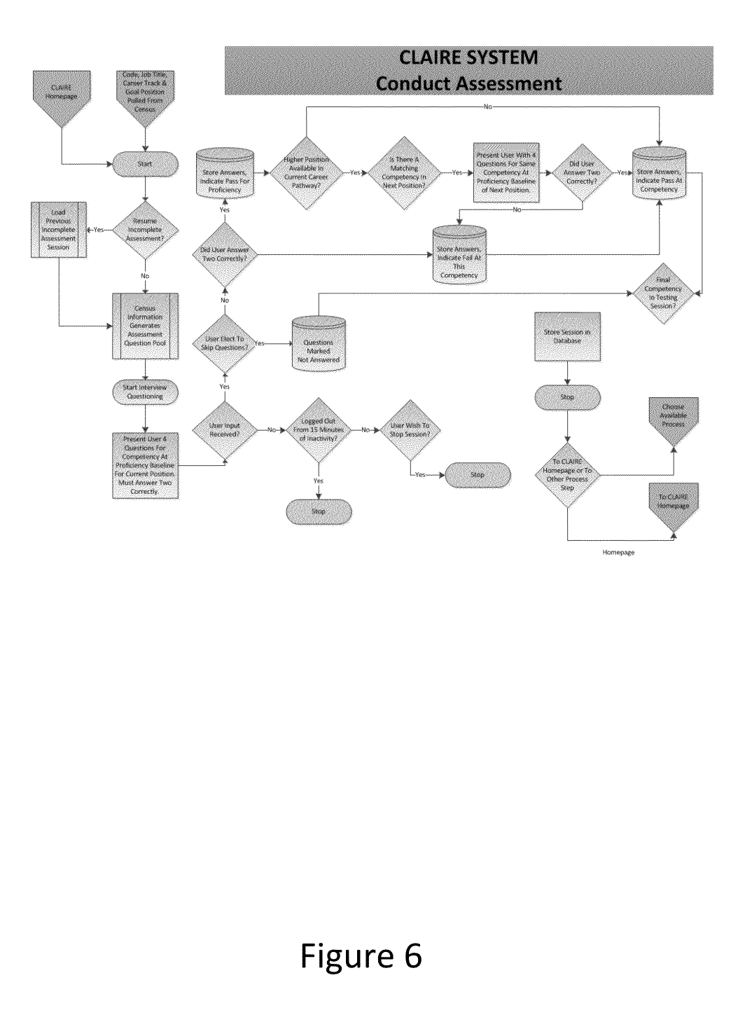

As illustrated by FIG. 6, based upon the information populated in the user profile, the career assessment encourages collaboration and real-time interaction between the user and the system, utilizing different formats to gain individual historical career experiences, skills, knowledge and training, while accurately assessing the practitioner within a small percentage variance level. Utilizing the completed assessment, as shown in FIG. 6, the career assessment recognizes and discovers variances identified between a hiring organization's or NASA's critical requirements, competencies, and proficiency levels provided by the hiring organization or NASA SME's.

The system assumes that the user has competency and proficiency levels equal to the identified baseline for the user current career position. Through the core assessment, the system interviews the user through a plurality of questions to validate the user's competencies and proficiencies against baseline competencies and proficiencies related to the user previous career position, current career position, next career position, and goal career position. Career position titles and related baseline information are provided by NASA SME's. The system refers to the NASA SME approved library of core competencies for ACFO positions when generating the career assessment questions and prompts the user from a pre-populated library of interview questions.

The core assessment of the system displays information to the user including a message informing the user that the interview process will soon begin prior to interviewing the user, the approximate time needed to complete the assessment, the total number of questions, and a sequence of questions based on a hierarchy of the most complex questions down to the most basic questions. Although the user is not required to complete the entire interview process within a single session, the user is required to complete the interview process in its entirety in order for the system to generate career guidance. If the user only partially completes the interview process and attempts to submit the assessment, then the system informs the user that an assessment cannot be generated.

The core assessment displays a plurality of questions and asks for user input in response to each question. At least a majority of the plurality of questions are answered correctly in order for the system to store the answers and indicate a pass for the competency's proficiency baseline for the user current position.

Further regarding the core assessment, the user may skip or bypass a question and the system will allows the user to return to that question at a later time. The system ends the interview process when the system encounters the last question and the user has responded to all of the questions. The system allows the user to save the session at any point during the interview process and continue the interview process at a later time. Saving the session saves all responses input by the user. The user may also review or edit previous responses. Once completed, the user may submit the core assessment.

System Perspective: The career assessment has AI capability built in and acts as a DSS, with data mining allowing the system to utilize the profile data, and automatically design an individual interview for each user. The interview process contains questions provided by NASA SME's for each career pathway and competency.
User Perspective: By utilizing the data provided in the profile, the career assessment conducts an interactive interview, specifically designed according to the user's individual current career experiences, career pathway, and goals. The questions posed allow the system to perform an unbiased assessment of the users' skills relevant to their position and is an essential step in the process of providing individualized guidance on maximizing proficiencies and mapping out future career progression.
Hiring Organization Perspective: With the goal of ongoing practitioner development to the benefit of both the individual and the organization, it is necessary for the career assessment to identify the user's proficiencies in regard to core competencies. Only then assessment information be utilized by the system to provide users with a personal assessment and unique guidance.

### Goal Assessment

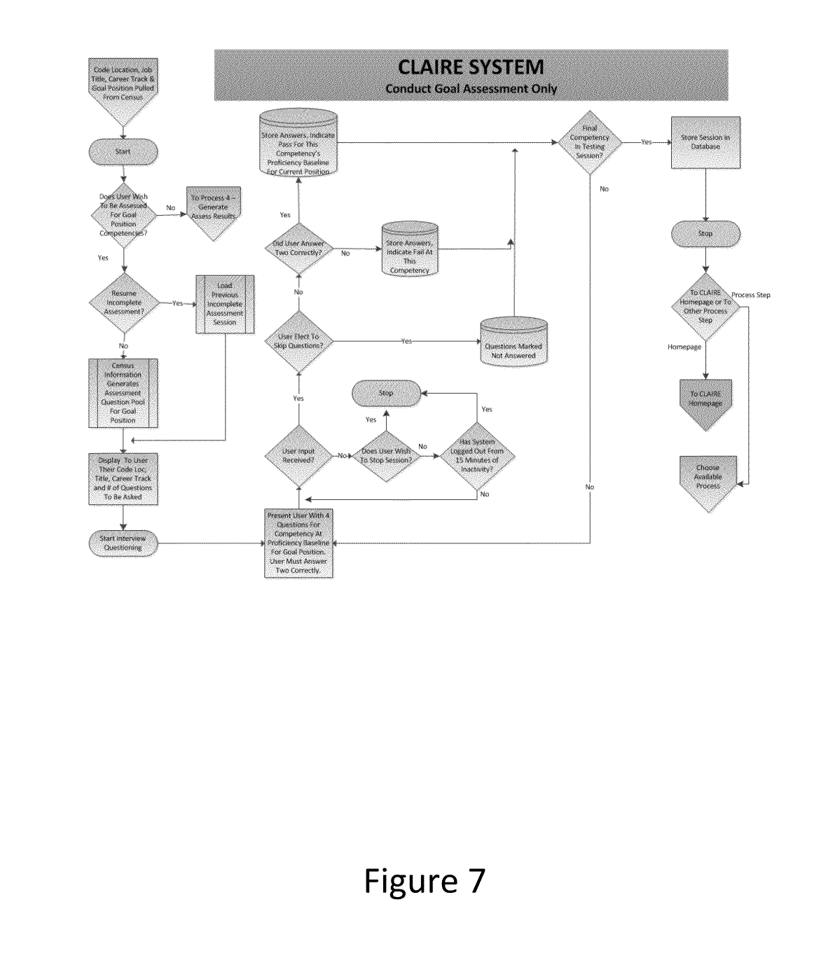

Referring now to FIG. 7, the goal assessment is similar to the core assessment, except the user current career position is compared to the user stated goal position. It is possible for the user next career position to be the same as the user stated goal position, as the user's goal may include earning a promotion to the next career position.

System Perspective: The system completes the goal “what if” scenario if the user selects this functionality. Furthermore, the goal assessment is not completed until the core assessment is completed.
User Perspective: The system provides an ability to map out the user's long-term career desires and goals, even if not immediately attainable.
Hiring Organization: By being able to identify and support an employee's long term career aspirations, the hiring organization continues to support their own internal organizational career development goals.

### Assessment Generation

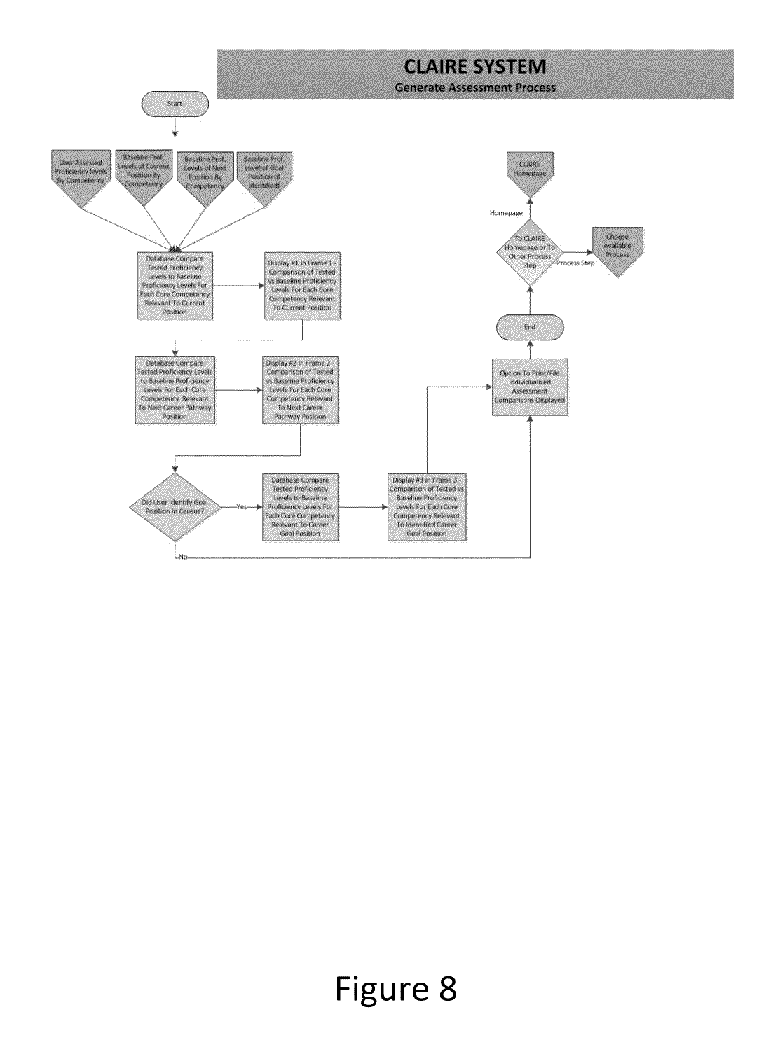

FIG. 8 illustrates a system and method for utilizing the user profile, the baseline competency and proficiency level information associated with the employee's current position and the answers provided during the interview to generate an intelligent assessment of the user's competencies and proficiency levels against a standardized approved baseline. Personalized assessments are generated for baseline comparison with the user's current position as well as the next position in the user's career track.

The system assessment provides and identifies deltas between baseline proficiency levels and the user's assessed proficiency level for each relevant competency. The system detects any updates to the user profile which prompts the user to complete a re-assessment.

System Perspective: The combination of the profile with the answers provided during the interview and the backend DSS/data mining automatically generates an unbiased assessment of the user's competency proficiency levels. This assessment is then analyzed against the required career pathway competency and associated proficiency levels provided by a hiring organizations experts or NASA SME's.
User Perspective: The user's ability to see an unbiased assessment free of any judgment prejudice of a user's skills against the needs of the business, career advancement, and goals lead to a roadmap of the user's proficiency levels against the baseline, thus identifying areas of competence, as well as areas where enhancements might prove beneficial to the user's career advancement.
Hiring Organization Perspective: A standardized assessment of employees leading to the advancement of competency skills increase the pool of candidates to satisfy the needs of the hiring organization or NASA ACFO.

### Guidance

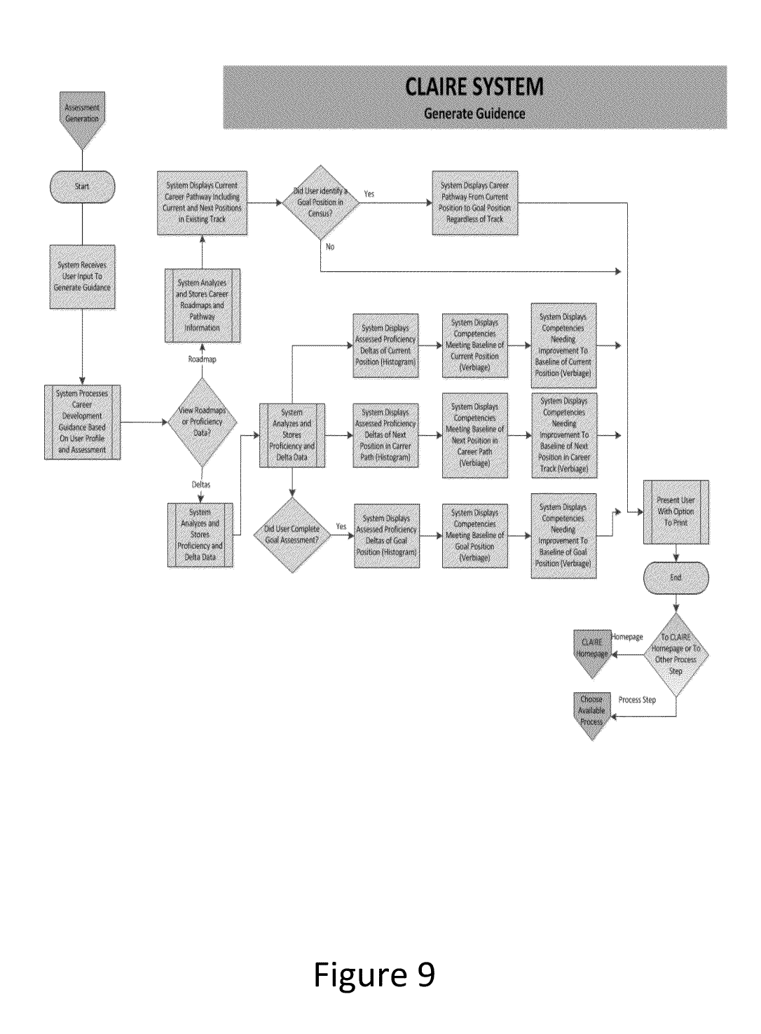

Referring to FIG. 9, a practitioner's “needs assessment” can identify a gap between the performance required by a hiring organization or the NASA Directorate and current performance leading to career advancement. When a difference exists, the career assessment analyzes the deltas and provides methods for closing the gap. By utilizing the practitioner assessment and specific career information, the career assessment is a virtual guidance counselor and provides a roadmap to assist the user in attaining the levels of proficiencies needed for career advancement.

System Perspective: The system provides a “career roadmap” based on each user's completed assessment and background data provided for career experiences, skills, needs, and goals in the profile. The analysis compares the deltas identified by a user's competency level to a hiring organization's or NASA ACFO's competency requirements by relevant career pathway.
User Perspective: By obtaining a career roadmap, the user has the ability to utilize this information for on-going career development. Utilizing the report on deltas identified for competencies allow the user to progress to the next career step.
Hiring Organization Perspective: The career assessment's career guidance leads to a more efficient means of practitioner career development, improves practitioner proficiency and thus the hiring organization's proficiency. A consistently developing workforce also provides for a continuous population of a qualified candidate pool available to meet future needs of the hiring organization.

### Outreach

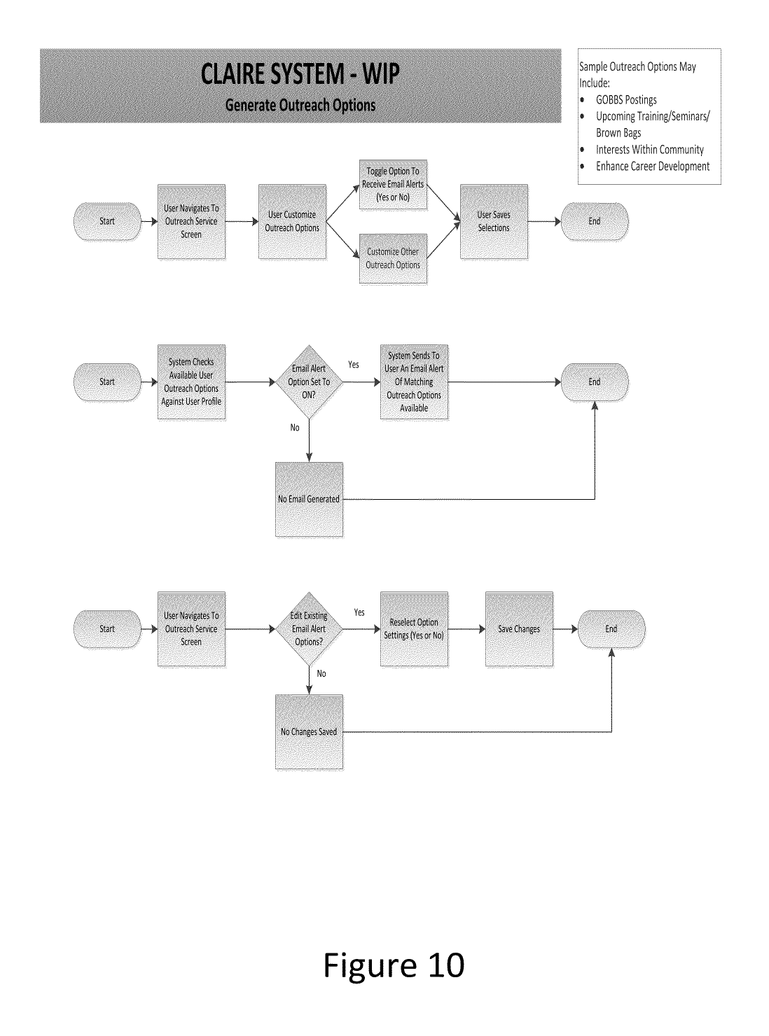

As illustrated by FIG. 10, the career assessment proactively provides individual users with unique information relevant to their career roadmap for attaining personal career progression and goals, interests identified, listed job opportunities, knowledge exchange, best practices, rules and tools, and case studies. In addition, the career assessment generates such communications based upon user specifications and information obtained through the organization's environment, and various systems that feed into the systems database.

System Perspective: The career assessment provides interactive guidance including educational planning and opportunities, professional development opportunities, listed job opportunities, knowledge exchange, best practices, rules and tools, and case studies. An interactive approach occurs between the user and the system during the user logon and logout by providing notifications from the roadmap.
User Perspective: Gain a “guidance counselor” who continuously reviews and monitors data, provides notifications, educational opportunities, professional development opportunities, job opportunities and guidance based on assessment results for career advancement, or knowledge exchange including a group of people or online resources available to share knowledge, discuss ideas, and a wide range of topics.
Hiring Organization Perspective: The career assessment's continued monitoring of user needs and interests and proactive outreach of relevant activities and opportunities keeps career development an ongoing activity. As an ongoing activity, the career assessment enables a user's skills to be continually enhanced to the benefit the individual employee and hiring organization.

### Reporting

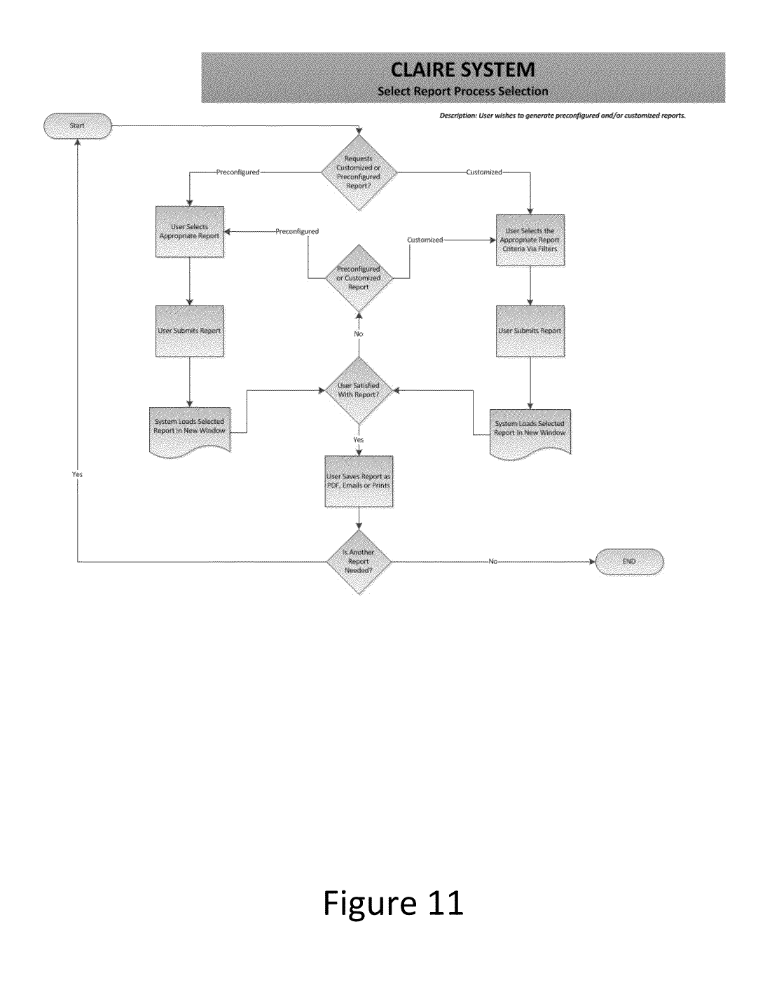

FIG. 11 illustrates that the system contains a reporting capability to produce reports (Metrics, User and Administrative).

System Perspective: The career assessment provides a reporting capability for all completed assessments, roadmaps, and guidance.
User Perspective: Ability to generate a record of individual user assessment, guidance for future reference and means of tracking user career growth, needs and progression.
Hiring Organization Perspective: The system allows the user to track their career development which benefits the organization by increasing the overall skills available to meet the organization's needs.

### Requirements Traceability Matrix

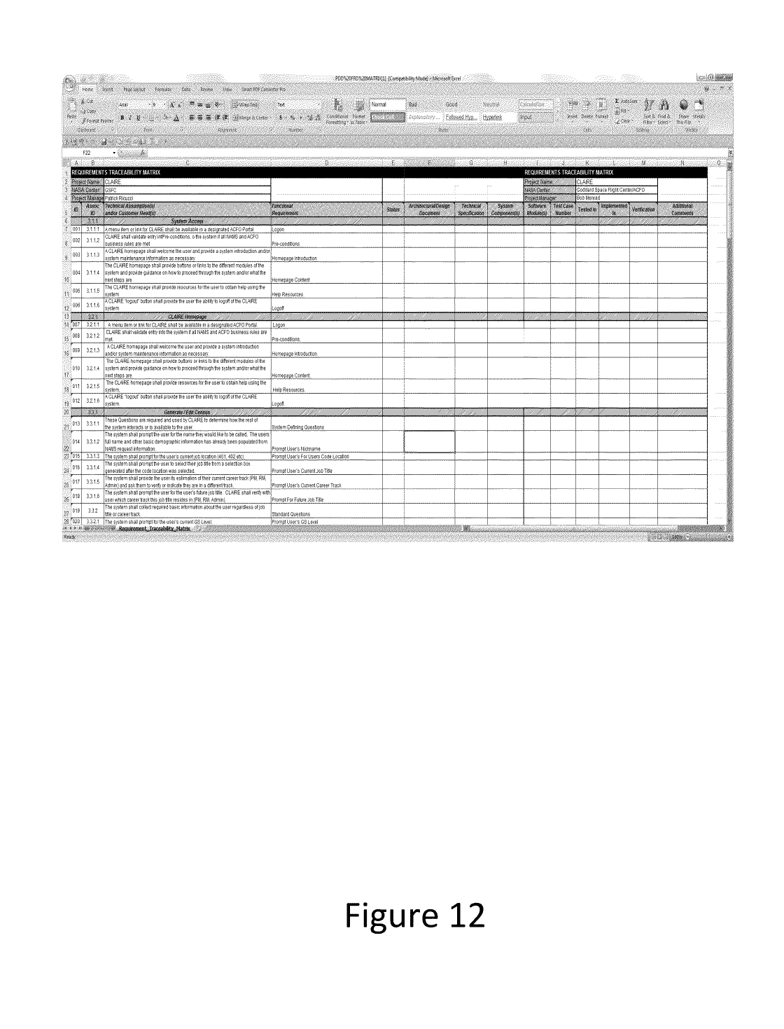

Referring now to FIG. 12, the requirements traceability matrix (RTM) provides a method for tracking the functional requirements and their implementation through the development process in the career assessment system.

Each requirement is included in the matrix along with its associated section number. As the project progresses, the RTM is updated to reflect each requirement's status and include a change control process. When the product is ready for system testing, the matrix lists each requirement, what product component addresses it, and what test verifies that it is correctly implemented.

Any changes of requirement in a hiring organization or NASA ACFO are maintained in the change control column and section of the RTM. This column includes the date, name of person who made the change and comments/background. All changes are discussed, approved and signed off by the organization.

1. A method of providing career development and advancement management within NASA, the method comprising the steps of:
consolidating a NASA employee's career experiences, knowledge, skills and abilities;
automating career guidance and a career pathway roadmap of the NASA employee's career development and advancement based on the NASA employee's career experiences, knowledge, skills and abilities; and
providing the NASA employee with a career management tool including a core assessment, the career guidance, and the career pathway roadmap of the NASA employee's experiences, knowledge, skills and abilities,
wherein said career management tool is operated by NASA, under complete control of the NASA employee, and confidentially generates the career assessment so as to be free of any judgment prejudice.

2. The method of claim 1, further comprising automatically matching and displaying a plurality of interview questions to the NASA employee based on a career pathway, job title, core competencies, and associated proficiency levels of the NASA employee.

3. The method of claim 1, further comprising interacting with and prompting the NASA employee to provide profile data to create the interview questions and census data.

4. The method of claim 1, wherein the step of providing the career assessment determines a gap between a performance required by a NASA employee current career pathway position and a NASA employee next career pathway position, and wherein the career pathway roadmap provides assistance in closing the gap.

5. The method of claim 1, further comprising generating outreach services.

6. The method of claim 1, further comprising generating a report including displaying results, roadmaps and guidance.

7. A method of providing career development and advancement management within NASA, the method comprising the steps of:
accessing a non-transitory interactive computing system;
accessing a homepage wherein buttons or links are displayed to a NASA employee and connect to a plurality of steps for providing the NASA employee with a career assessment;
prompting the NASA employee to create a profile by inputting data, thereby forming profile data,
wherein said profile data includes NASA employee personal information, career information, and outreach based information;
utilizing the profile data to generate census data, a core assessment, and display a plurality of core assessment interview questions,
wherein said core assessment interview questions are designed to validate the NASA employee's competencies and proficiencies against a baseline competencies and proficiencies related to a NASA employee previous career position, a current career position, a next career position, and a goal career position;
automatically generating results based on the NASA employee's answers to a plurality of core assessment interview questions,
wherein said career management tool is operated by NASA, under complete control of the NASA employee, and confidentially generates the career assessment so as to be free of any judgment prejudice;
generating career guidance utilizing said results; and
generating outreach services utilizing said results.

8. The method of claim 7, wherein after the profile is created said system generates one of a denial of access response or an access permitted response, and wherein determining the access permitted response displays a menu item or link, validates the NASA employee, and displays the homepage.

9. The method of claim 7, wherein said step of accessing the homepage includes displaying buttons or links on the homepage that connect to each of the said plurality of steps, providing guidance on how to proceed through the system, and providing instructions on receiving results.

10. The method of claim 7, wherein the system displays information to the NASA employee, the information including a message informing the NASA employee that an interview process will begin prior to interviewing the NASA employee, an approximate time needed to complete the assessment, a total number of questions, and a sequence of questions based on a hierarchy of a plurality of complex questions down to a plurality of basic questions.

11. The method of claim 7, wherein the system displays a plurality of core assessment questions and asks for NASA employee input in response to each core assessment question, and wherein at least a majority of the plurality of core assessment questions are answered correctly in order for the system to store answers and indicate a pass for the baseline competencies and proficiencies for the NASA employee current career position.

12. The method of claim 7, wherein utilizing the census data generates a goal assessment, displays interview questions, and generates a goal assessment result after the core assessment interviews the NASA employee.

13. The method of claim 7, wherein generating career guidance includes displaying career roadmaps, determining deltas, and providing assistance to the NASA employee.

14. The method of claim 7, wherein the step of generating the outreach services includes continuously monitoring NASA employee needs, interests, and career opportunities for career development and advancement.

15. The method of claim 7, further comprising generating a report including displaying the NASA employee results, roadmaps, and guidance.

16. A method of providing career development and advancement management within NASA, the method comprising the steps of:
accessing a non-transitory interactive computing system;
accessing a homepage wherein buttons or links are displayed to a NASA employee and connect to each step for providing the NASA employee with results;
prompting the NASA employee to create a profile by inputting data, thereby forming profile data,
wherein said profile data includes NASA employee personal information, career information, and outreach based information;
utilizing the profile data to generate a core assessment and display a set of core assessment interview questions,
wherein said core assessment interviews the NASA employee through a plurality of questions to validate the NASA employee's competencies and proficiencies against a baseline competencies and proficiencies related to a NASA employee previous career position, a current career position, a next career position, and a goal career position, and
wherein said career management tool is operated by NASA, under complete control of the NASA employee, and confidentially generates the career assessment so as to be free of any judgment prejudice;
generating career guidance utilizing said results,
wherein said career guidance displays the career assessment including a career roadmap, deltas, and assistance to the NASA employee,
wherein the career assessment of the NASA employee's competencies and proficiency levels provide a personalized result that is generated for baseline comparison with a NASA employee current position as well as the NASA employee next position in a NASA employee career track, and
wherein the assessment deltas provide the difference between the baseline proficiencies and a NASA employee assessed proficiency level for each relevant competency; and
generating outreach services utilizing said results.

17. The method of claim 16, wherein the step of accessing said system validates or invalidates the NASA employee by generating one of a denial of access response or an access permitted response, respectively, and
wherein determining the access permitted response displays a menu item or link to system modules, validates the NASA employee, and displays the homepage.

18. The method of claim 16, wherein said step of accessing the homepage includes displaying buttons or links on the homepage that connect to each of the said steps, providing guidance on how to proceed through the system, and providing instructions on receiving results.

19. The method of claim 16, wherein the system displays information to the NASA employee including a message informing the NASA employee that an interview process will begin prior to interviewing the NASA employee, an approximate time needed to complete the career assessment, a total number of questions, and a sequence of questions based on a hierarchy of a plurality of complex questions down to a plurality of basic questions.

20. The method of claim 16, wherein the system displays a plurality of core assessment questions and asks for NASA employee input in response to each question, and wherein at least a majority of the of the plurality of core assessment questions are answered correctly in order for the system to store answers and indicate a pass for the baseline competencies and proficiencies for the NASA employee current career position.

21. The method of claim 16, wherein utilizing the census data generates a goal assessment, displays interview questions, and generates a goal assessment result after the core assessment interviews the NASA employee.

22. The method of claim 16, wherein the step of generating career guidance displays career roadmaps, determines deltas, and provides assistance to the NASA employee.

23. The method of claim 16, wherein generating the outreach services includes continuously monitoring NASA employee needs, interests, and career opportunities for career development and advancement.

24. The method of claim 16, further comprising generating a report including displaying the NASA employee's results, roadmaps, and guidance.

25. A method of providing career development and advancement management within the government, the method comprising the steps of:
consolidating a government employee's career experiences, knowledge, skills and abilities;
automating career guidance and a career pathway roadmap of the government employee's career development and advancement in a career position based on the government employee's career experiences, knowledge, skills and abilities; and
providing the government employee with a career management tool including a core assessment, the career guidance, and the career pathway roadmap of the government employee's experiences, knowledge, skills and abilities,
wherein said career management tool is operated by a governmental organization, under complete control of the government employee, and confidentially generates results so as to be free of any judgment prejudice.

26. The method of claim 25, further comprising automatically matching and displaying a plurality of interview questions to the government employee based on a career pathway, job title, core competencies, and associated proficiency levels of the government employee.

27. The method of claim 25, further comprising interacting with and prompting the government employee for profile data to create the interview questions and census data.

28. The method of claim 28, wherein the step of providing the results determines a gap between a performance required by a government employee current career pathway position and a government employee next career pathway position, and wherein the career pathway roadmap provides assistance in closing the gap.

29. The method of claim 25, further comprising generating outreach services.

30. The method of claim 25, further comprising generating a report including displaying results, roadmaps and guidance.

31. A method of providing career development and advancement management within the government, the method comprising the steps of:
accessing a non-transitory interactive computing system;
accessing a homepage wherein buttons or links are displayed to a government employee and connect to a plurality of steps for providing the government employee with results;
prompting the government employee to create a profile by inputting data, thereby forming profile data,
wherein said profile data includes government employee personal information, career information, and outreach based information;
utilizing the census data to generate a core assessment and display a set of core assessment interview questions,
wherein said core assessment interview questions are designed to validate the government employee's competencies and proficiencies against a baseline competencies and proficiencies related to a government employee previous career position, a current career position, a next career position, and a goal career position;
automatically generating results based on the government employee's answers to a plurality of core assessment interview questions,
wherein said career management tool is operated by a governmental organization, under complete control of the government employee, and confidentially generates results so as to be free of any judgment prejudice;
generating career guidance utilizing said results; and
generating outreach services utilizing said results.

32. The method of claim 31, wherein after the profile is created said system generates one of a denial of access response or an access permitted response, and wherein determining the access permitted response displays a menu item or link, validates the government employee, and displays the homepage.

33. The method of claim 31, wherein said step of accessing the homepage includes displaying buttons or links on the homepage that connect to each of the said plurality of steps, providing guidance on how to proceed through the system, and providing instructions on receiving results.

34. The method of claim 31, wherein the system displays information to the government employee, the information including a message informing the government employee that an interview process will begin prior to interviewing the government employee, an approximate time needed to complete the assessment, a total number of questions, and a sequence of questions based on a hierarchy of a plurality of complex questions down to a plurality of basic questions.

35. The method of claim 31, wherein the system displays three core assessment questions and asks for government employee input in response to each question, and wherein at least a majority of the of the plurality of core assessment questions are answered correctly in order for the system to store answers and indicate a pass for the baseline competencies and proficiencies for the government employee current career position.

36. The method of claim 31, wherein utilizing the census data generates a goal assessment, displays interview questions, and generates a goal assessment result after the core assessment interviews the government employee.

37. The method of claim 31, wherein the step of generating career guidance includes displaying career roadmaps, determining deltas, and providing assistance to the government employee.

38. The method of claim 31, wherein the step of generating the outreach services includes continuously monitoring government employee needs, interests, and career opportunities for career development and advancement.

39. The method of claim 31, further comprising generating a report including displaying the results, roadmaps, and guidance.

40. A method of providing career development and advancement management within the government, the method comprising the steps of:
accessing a non-transitory interactive computing system;
accessing a homepage wherein buttons or links are displayed to a government employee and connect to each step for providing the government employee with a career management tool;
prompting the government employee to create a profile by inputting data, thereby forming profile data,
wherein said profile data includes government employee personal information, career information, and outreach based information;
utilizing the profile data to generate a core assessment and display a set of core assessment interview questions,
wherein said core assessment interviews the government employee through a plurality of questions to validate the government employee's competencies and proficiencies against a baseline competencies and proficiencies related to a government employee next career position, and
wherein said career management tool is operated by a governmental organization, under complete control of the government employee, and confidentially generates results so as to be free of any judgment prejudice;
generating career guidance utilizing said results,
wherein said career guidance displays results including a career roadmap, deltas, and assistance to the government employee,
wherein results of the government employee's competencies and proficiency levels provide a personalized result that is generated for baseline comparison with a government employee current career position as well as the government employee next career position in a government employee career track, and
wherein deltas provide the difference between the baseline proficiencies and a government employee assessed proficiency level for each relevant competency; and
generating outreach services utilizing said results.

41. The method of claim 40, wherein the step of accessing said system validates or invalidates the government employee by generating one of a denial of access response or an access permitted response, respectively, and
wherein determining the access permitted response displays a menu item or link to system modules, validates the government employee, and displays the homepage.

42. The method of claim 40, wherein said step of accessing the homepage includes displaying buttons or links on the homepage that connect to each of the said steps, providing guidance on how to proceed through the system, and providing instructions on receiving results.

43. The method of claim 40, wherein the system displays information to the government employee including a message informing the government employee that an interview process will begin prior to interviewing the government employee, an approximate time needed to complete the assessment, a total number of questions, and a sequence of questions based on a hierarchy of a most complex questions down to a most basic questions.

44. The method of claim 40, wherein the system displays a plurality of core assessment questions and asks for government employee input in response to each question, and wherein at least a majority of the of the plurality of core assessment questions are answered correctly in order for the system to store answers and indicate a pass for the competency's proficiency baseline for the government employee current career position.

45. The method of claim 40, wherein utilizing the profile data generates a goal assessment, displays interview questions, and generates a goal assessment result after the core assessment interviews the government employee.

46. The method of claim 40, wherein generating career guidance displays career roadmaps, determines deltas, and provides assistance to the government employee.

47. The method of claim 40, wherein generating the outreach services includes continuously monitoring government employee needs, interests, and career opportunities for career development and advancement.

48. The method of claim 40, further comprising generating a report including displaying the results, roadmaps, and guidance.

49. A method of providing career development and advancement management within a corporation, the method comprising the steps of:
consolidating a corporate employee's career experiences, knowledge, skills and abilities;
automating career guidance and a career pathway roadmap of the corporate employee's career development and advancement in a corporate human resources office; and
providing the corporate employee with a career management tool including the career guidance and the career pathway roadmap of the corporate employee's experiences, knowledge, skills and abilities,
wherein said career management tool is operated by the corporate human resources office, is under complete control of the corporate employee, and confidentially generates results so as to be free of any judgment prejudice.

50. The method of claim 49, further comprising automatically matching and displaying a plurality of interview questions to the corporate employee based on a career pathway, job title, core competencies, and associated proficiency levels of the corporate employee.

51. The method of claim 50, further comprising interacting with and prompting the corporate employee for profile data to create the interview questions.

52. The method of claim 49, wherein the career assessment determines a gap between a performance required by a corporate employee current career pathway position and a corporate employee next career pathway position, and wherein the career pathway roadmap provides assistance in closing the gap.

53. The method of claim 49, further comprising generating outreach services.

54. The method of claim 49, further comprising generating a report including displaying results, roadmaps and guidance.

55. A method of providing career development and advancement management within a corporation, the method comprising the steps of:
accessing a non-transitory interactive computing system;
accessing a homepage wherein buttons or links are displayed to a corporate employee and connect to each step for providing the corporate employee with a career management tool;
prompting the corporate employee to create a profile by inputting data, thereby forming profile data,
wherein said profile data includes corporate employee personal information, career information, and outreach based information;
utilizing the profile data to generate census data, a core assessment, and display a set of core assessment interview questions,
wherein said core assessment interview questions are designed to validate the corporate employee's competencies and proficiencies against a baseline competencies and proficiencies related to a corporate employee previous career position, a current career position, a next corporate position, and a goal career position;
automatically generating results based on the corporate employee's answers to a plurality of core assessment interview questions,
wherein said career management tool is operated by a corporate human resources office, under complete control of the corporate employee, and confidentially generates the career assessment so as to be free of any judgment prejudice;
generating career guidance utilizing said results; and
generating outreach services utilizing said results.

56. The method of claim 55, wherein after the census is created said system generates one of a denial of access response or an access permitted response, and wherein determining the access permitted response displays a menu item or link, validates the corporate employee, and displays the homepage.

57. The method of claim 55, wherein said step of accessing the homepage includes displaying buttons or links on the homepage that connect to each of the said plurality of steps, providing guidance on how to proceed through the system, and providing instructions on receiving results.

58. The method of claim 55, wherein the system displays information to the corporate employee, the information including a message informing the corporate employee that an interview process will begin prior to interviewing the corporate employee, an approximate time needed to complete the assessment, a total number of questions, and a sequence of questions based on a hierarchy of a plurality of complex questions down to a plurality of basic questions.

59. The method of claim 55, wherein the system displays a plurality of core assessment questions and asks for corporate employee input in response to each question, and wherein at least a majority of the of the plurality of the core assessment questions are answered correctly in order for the system to store answers and indicate a pass for the baseline competencies and proficiencies for the corporate employee current career position.

60. The method of claim 55, wherein utilizing the census data generates a goal assessment, displays interview questions, and generates a goal assessment result after the core assessment interviews the corporate employee.

61. The method of claim 55, wherein the step of generating career guidance includes displaying career roadmaps, determining deltas, and providing assistance to the corporate employee.

62. The method of claim 55, wherein the step of generating the outreach services includes continuously monitoring corporate employee needs, interests, and career opportunities for career development and advancement.

63. The method of claim 55, further comprising generating a report including displaying the results, roadmaps, and guidance.

64. A method of providing career development and advancement management within a corporation, the method comprising the steps of:
accessing a non-transitory interactive computing system;
accessing a homepage wherein buttons or links are displayed to a corporate employee and connect to each step for providing the corporate employee with a career management tool;
prompting the corporate employee to create a profile by inputting data, thereby forming profile data,
wherein said profile data includes corporate employee personal information, career information, and outreach based information;
utilizing the profile data to generate a core assessment and display a set of core assessment interview questions,
wherein said core assessment interviews the corporate employee through a plurality of questions to validate the corporate employee's competencies and proficiencies against a baseline competencies and proficiencies related to a corporate employee previous career position, a current career position, a next corporate position, and a goal career position; and
wherein said career management tool is operated by the corporate human resources office, under complete control of the corporate employee, and confidentially generates results so as to be free of any judgment prejudice;
generating career guidance utilizing said core assessment result,
wherein said career guidance displays the results including a career roadmap, deltas, and assistance to the corporate employee,
wherein the career assessment of the corporate employee's competencies and proficiency levels provide a personalized result that is generated for baseline comparison with a corporate employee current corporate position as well as the corporate employee next corporate position in a corporate employee career track, and
wherein deltas provide the difference between the baseline proficiencies and a corporate employee assessed proficiency level for each relevant competency; and
generating outreach services utilizing said results.

65. The method of claim 64, further comprising automatically matching and displaying a plurality of interview questions to the corporate employee based on a corporate employee career pathway, job title, core competencies, and associated proficiency levels for a corporate employee career path.

66. The method of claim 64, further comprising interacting with and prompting the corporate employee for profile data to create the interview questions.

67. The method of claim 64, wherein the assessment determines a gap between a performance required by a corporate employee current career pathway position and a corporate employee next career pathway position, and wherein the career pathway roadmap provides assistance in closing the gap.

68. The method of claim 64, further comprising generating outreach services.

69. The method of claim 64, further comprising generating a report including displaying the results, roadmaps and guidance.

70. A device for providing career development and advancement management, comprising:
a non-transitory interactive computing system;
a system access module;
a homepage module;
a census module;
a core assessment module;
a generate assessment module;
a guidance module;
an outreach module;
a reporting module;
and a requirements traceability matrix module.

71. The device of claim 70, further comprising a goal assessment module.

72. The device of claim 70, wherein the requirements traceability matrix module is configured with an ID, associated ID, technical assumption and functional requirement.
